(19) United States
(12) Patent Application Publication
(10) Pub. No.: US 2005/0074584 A1
(43) Pub. Date: Apr. 7, 2005

(54) Liner composites adapted to attain three-dimensional configurations

(75) Inventors: Georgia L. Zehner, Larsen, WI (US); Duane G. Uitenbroek, Little Chute, WI (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/680,968

(22) Filed: Oct. 7, 2003

(51) Int. Cl. B32B 3/00; B32B 1/00

(52) U.S. Cl. 428/174; 442/394; 604/385.25; 604/385.01; 604/385.21; 604/385.22; 604/385.23; 604/385.24

(57) ABSTRACT

Liner composites (30) suitable for incorporation into disposable absorbent articles. The liner composites (30) include an extensible liner material (32) and a non-tensioned elastic (34). The liner composites (30) are adapted to attain three-dimensional configurations upon activation.

### BACKGROUND

The present invention relates to liner composites. More particularly, the present invention relates to liner composites suitable for incorporation into disposable absorbent articles.

Disposable absorbent articles such as diapers, training pants, adult incontinent garments and the like are well known. In order to improve the ability of such disposable absorbent articles to absorb and contain discharged body wastes, it has become common to include on such articles mechanical systems for controlling the movement of body wastes. Such mechanical systems include longitudinally and/or laterally extending containment flaps.

Containment flaps, for example, have historically been formed by attaching a set of elastics to a sheet of barrier material. Containment flaps formed in this manner generally have a proximal edge and an elasticized distal edge opposite the proximal edge. The containment flap is usually then attached to the bodyfacing surface of a disposable absorbent article such that the distal edge of the containment flap is maintained in a generally up-right position. By being maintained in such an up-right position, the distal edge of the containment flap contacts the body of a wearer thus presenting a lateral barrier to the flow of bodily waste. Similarly, waist caps generally are a separate piece of elasticized barrier material also attached to the bodyfacing surface of a disposable absorbent article.

The attachment of these individual mechanical systems is typically accomplished through rather complex manufacturing processes that may represent a rate-limiting step with respect to the production of such disposable absorbent articles. Moreover, the attachment of these various mechanical systems has resulted in some disposable absorbent articles having bodyfacing surfaces that in appearance are rather complex. As a result, there has remained a need to provide disposable absorbent articles that are relatively easier to manufacture and have less complex-appearing bodyfacing surfaces prior to being donned on a wearer.

### SUMMARY

In response to the foregoing need, the present inventors undertook intensive research and development efforts that resulted in the discovery of unique liner composites suitable for incorporation on the bodyfacing side of a variety of disposable absorbent articles. One version of the liner composites of the present invention includes an extensible, fluid permeable liner material and a non-tensioned elastic. The liner material has an upper surface and an opposing lower surface. The non-tensioned elastic is associated with a portion of a surface of the liner material. Upon activation, at least that portion of the liner composite adjacent where the liner material and the non-tensioned elastic are associated is adapted to have a retraction capability differential of at least 10% and attain a three-dimensional configuration.

In another version, a disposable absorbent article (having a longitudinal centerline and a lateral centerline) includes a liquid impermeable outer cover, a liner composite and an absorbent core. The absorbent core is disposed intermediate the liner composite and the outer cover. In this version, the liner composite includes an extensible, fluid permeable liner material and a non-tensioned elastic. The liner material has an upper surface and an opposing lower surface. The non-tensioned elastic is associated with at least a portion of a surface of the liner material. Upon activation, at least that portion of the liner composite adjacent where the liner material and the non-tensioned elastic are associated is adapted to have a retraction capability differential of at least 10% and attain a three-dimensional configuration. At least that portion of the liner material adjacent where the liner material and the non-tensioned elastic are associated is adapted to extend no less than 25%.

### DRAWINGS

The foregoing and other features and aspects of the present invention and the manner of attaining them will become more apparent, and the invention itself will be better understood by reference to the following description, appended claims and accompanying drawings, where:

FIG. 1 illustrates a version of the liner composite;

FIGS. 2 through 9 illustrate several configurations of the non-tensioned elastic;

FIG. 10A illustrates an application of the liner composite in a pre-activated configuration;

FIG. 10B illustrates the application of FIG. 10A in an activated configuration;

FIG. 11A illustrates an application of the liner composite in a pre-activated configuration;

FIG. 11B illustrates the application of FIG. 11A in an activated configuration;

FIG. 12A illustrates an application of the liner composite in a pre-activated configuration;

FIG. 12B illustrates the application of FIG. 12A in an activated configuration;

FIG. 13A is an exaggerated illustration of a version of the liner composite, in a pre-activated configuration, incorporated into a disposable absorbent article;

FIG. 13B illustrates a cross-sectional view of the disposable absorbent article of FIG. 13A;

FIG. 14A is an exaggerated illustration of a version of the liner composite, in an activated configuration, incorporated into a disposable absorbent article;

FIG. 14B illustrates a cross-sectional view of the disposable absorbent article of FIG. 14A;

FIG. 15 representatively illustrates a partially cut-away, top plan view of the bodyfacing or upper surface of a disposable absorbent article incorporating a version of the liner composite;

FIG. 16 representatively illustrates a partially cut-away, top plan view of the bodyfacing or upper surface of a disposable absorbent article incorporating a version of the liner composite;

FIG. 17A representatively illustrates a top plan view of the bodyfacing or upper surface of a disposable absorbent article incorporating a version of the liner composite;

FIG. 17B representatively illustrates a lateral, cross-sectional view, taken with respect to line 17B-17B of FIG. 17A, of a version of the liner composite in a pre-activated configuration; and

FIG. 17C representatively illustrates a lateral, cross-sectional view of a disposable absorbent article similar to that illustrated in FIG. 17B having a version of the liner composite in an activated configuration.

### DESCRIPTION

As illustrated in FIG. 1, the liner composite (30) of the present invention includes a sheet of extensible, fluid permeable liner material (32) and a non-tensioned elastic (34). The liner material (32) has a bodyfacing or upper surface (36) and an opposing or lower surface (38). The liner material (32) and the non-tensioned elastic (34) are connected or otherwise associated together in an operable manner. As used herein when describing the liner material (32) in relation to the non-tensioned elastic (34) and vice versa, the term “associated” encompasses configurations in which the non-tensioned elastic (34) is directly joined to the liner material (32), and configurations wherein the non-tensioned elastic (34) is indirectly joined to the liner material (32) by affixing the non-tensioned elastic (34) to intermediate members which in turn are affixed to the liner material (32). The non-tensioned elastic (34) is connected or otherwise associated with the liner material (32) prior to extending the liner material (32).

The term “extensible”, as used herein, is intended to refer to members or components that can increase in at least one of their dimensions in the x-y plane. For example, the liner material (32)—or portions thereof—is desirably capable of extending no less than 10; alternatively, no less than 15; alternatively, no less than 20; alternatively, no less than 25; alternatively, no less than 30; alternatively, no less than 35; alternatively, no less than 40; alternatively, no less than 45; alternatively, no less than 50; alternatively, no less than 60; alternatively, no less than 70; alternatively, no less than 75; alternatively, no less than 80; alternatively, no less than 90; alternatively, no less than 100; alternatively, no less than 110; alternatively, no less than 120; alternatively, no less than 125; alternatively, no less than 130; alternatively, no less than 140; alternatively, no less than 150; alternatively, no less than 155; alternatively, no less than 160; alternatively, no less than 165; alternatively, no less than 170; alternatively, no less than 175; alternatively, no less than 180; alternatively, no less than 185; alternatively, no less than 190; and finally, alternatively, no less than 195% of its unextended length (and/or its unextended width). In addition, the liner material (32)—or portions thereof—is desirably capable of extending no more than 200; alternatively, no more than 195; alternatively, no more than 190; alternatively, no more than 185; alternatively, no more than 180; alternatively, no more than 175; alternatively, no more than 170; alternatively, no more than 165; alternatively, no more than 160; alternatively, no more than 155; alternatively, no more than 150; alternatively, no more than 140; alternatively, no more than 130; alternatively, no more than 125; alternatively, no more than 120; alternatively, no more than 110; alternatively, no more than 100; alternatively, no more than 90; alternatively, no more than 80; alternatively, no more than 75; alternatively, no more than 70; alternatively, no more than 60; alternatively, no more than 50; alternatively, no more than 45; alternatively, no more than 40; alternatively, no more than 35; alternatively, no more than 30; alternatively, no more than 25; alternatively, no more than 20; and finally, alternatively, no more than 15% of its unextended length (and/or its unextended width). Thus, the liner material (32)—or portions thereof—may have an extensibility ranging between no less than 10% up to no more than 200%; although the approximate extensibility of the liner material (32) may vary according to, inter alia, the general design and intended use of the liner composite (30).

In particular aspects, suitable extensible liner material (32) can provide an elongation of at least 50% when subjected to a tensile force of 10 gmf per inch (per 2.54 cm). The liner material (32) can also provide a substantially permanent deformation of at least 10% when subjected to a tensile force of 50 gmf per inch (per 2.54 cm) and then allowed to relax, after removal of the tensile force, for a period of 1 minute. It should be readily appreciated that the described removal of the applied force results in a zero applied tensile stress and a zero applied tensile force.

It should be noted that the elongation, extension or permanent deformation properties of the extensible liner material (32) are determined when the liner material (32) is dry. Additionally, the percentage of elongation, extension or permanent deformation can be determined in accordance with the following formula:
100*[(L−Lₒ)/(Lₒ)]
where: L=elongated length; and
Lₒ=initial length.

The extensible liner material (32) is suitably fluid permeable. When incorporated into a disposable absorbent article, the liner material (32) is in close proximity to the skin of the wearer. Consequently, the liner material (32) is desirably as compliant, soft feeling, and non-irritating to the wearer's skin as possible.

A suitable extensible liner material (32) may be manufactured from a wide range of materials including, but not limited to woven and nonwoven materials, apertured formed thermoplastic films, apertured plastic films, hydro-formed films, porous foams, reticulated foams, reticulated thermoplastic films, and thermoplastic scrims. Suitable woven and nonwoven materials can include natural fibers (e.g., wood or cotton fibers), synthetic or modified natural fibers (e.g., polymeric fibers, such as polyester, polypropylene fibers, and polyethylene, or polyvinylalcohol, starch base resins, polyurethanes, cellulose esters, nylon, and rayon fibers), or a combination of natural and synthetic fibers. When the extensible liner material (32) includes a nonwoven web, the web may be spunbonded, carded, wet-laid, meltblown, hydroentangled, combinations of the above, or the like.

There are several known methods of providing the liner material (32) described above with extensibility. A non-limiting number of these methods are described below. One such method would be to have the liner material (32) made extensible by forming it from extensible or stretchable materials. The term “stretchable”, as used herein, is intended to refer to articles that are extensible when stretching forces are applied to the article and offer some resistance to stretching. The liner material (32) can be made of crimped or coiled nonwoven fibrous materials that may contain an elastomeric or low modulus component. A particularly suitable extensible material for the liner material (32) is a necked spunbond web of polypropylene fibers having a basis weight of from about 5 to about 30 gsm. Such a web may be necked up to about 80%.

Another example would be to mechanically manipulate a suitable liner material (32). One such example of mechanical manipulation is described in U.S. Pat. No. 4,965,122, issued to Mormon (attorney docket number 8,730), the entire disclosure of which is incorporated herein by reference in a manner that is consistent (i.e., not in conflict) herewith. An example of a suitable extensible liner material (32) is a 50% necked, polypropylene spunbond having a basis weight of about 0.5 osy. Examples of suitable manufacturing techniques are also described in U.S. Pat. No. 4,965,122, issued to Mormon.

For purposes of the present discussion, the term “% necked” or “percent neckdown” is intended to refer to a ratio or percentage determined by measuring the difference between the pre-necked dimension and the necked dimension of a neckable material, and then dividing that difference by the pre-necked dimension of the neckable material. The percentage of necking (percent neck) can be determined in accordance with the description in the above-mentioned U.S. Pat. No. 4,965,122, issued to Mormon.

In addition to the foregoing, the liner material (32) may be treated with a surfactant. This can be accomplished by a variety of techniques known to those skilled in the art. Treating the liner material (32) with a surfactant generally renders the liner material (32) more hydrophilic. This typically results in liquid penetrating the liner material (32) faster than if it were not treated.

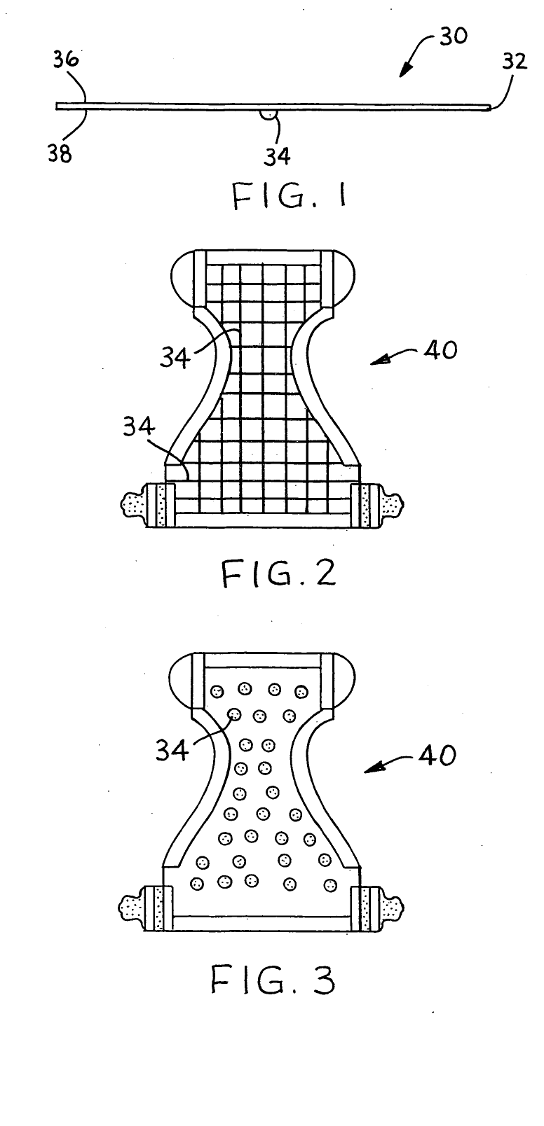

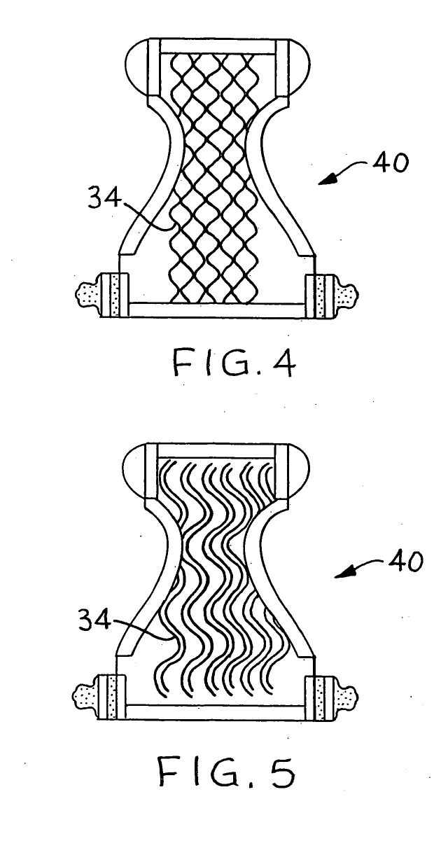

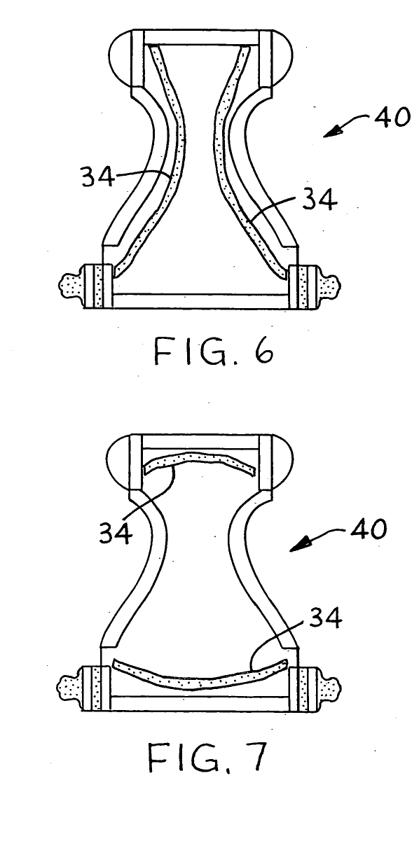

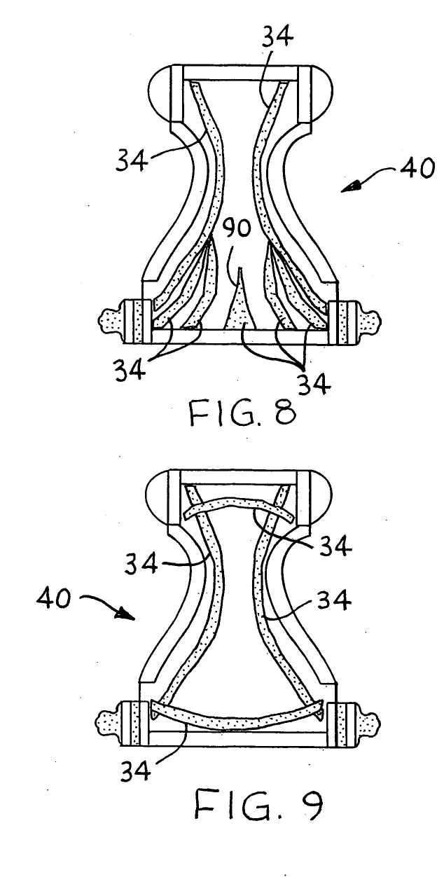

Elastic in the form of strands, bands, ribbons, sheets, laminated composites, films, filaments, fibrous webs, and the like, as well as combinations thereof, are connected or otherwise associated with the extensible liner material (32) in an operable manner while the elastic is in the relaxed or non-tensioned condition. The term “elastic”, as used herein, is intended to refer to strands, bands, ribbons, sheets, laminated composites, films, filaments, fibrous webs, and the like, as well as combinations thereof, that have a recovery of at least 25% or more of the extended dimension (e.g., [0.25*(L−Lₒ)]) after being stretched at room temperature. Suitable non-tensioned elastics (34) are generally relatively long and narrow, and are usually applied to the liner material (32) so as to be running in a longitudinally-orientated direction, a laterally-oriented direction, or a diagonally-oriented direction. Depending on the general design and intended use of the liner composite (30), the non-tensioned elastic (34) may be applied to the upper surface (36), the lower surface (38), or both surfaces (36, 38) of the liner material (32) in a variety of linear or curvilinear configurations including line, intermittent, dot, dash, and the like. Several non-limiting examples of these configurations are illustrated in FIGS. 2 through 9. The non-tensioned elastic (34) may also be in film, fluid, solid, ribbon, nonwoven, or woven web form in addition to rolls. Several materials suitable to serve as the non-tensioned elastic of the present invention are described in U.S. Pat. No. 6,245,050, issued to Odorzynski et al. (attorney docket number 10,933.1), the entire disclosure of which is hereby incorporated herein by reference in a manner that is consistent (ie., not in conflict) herewith. For example, identified in U.S. Pat. No. 6,245,050 are certain suitable elastomeric, hot melt, pressure-sensitive adhesives (e.g., Findley H2503 and H2504) available from Bostik Findley, Inc., a business having offices in Wauwatosa, Wis. Several of the hot melt, pressure-sensitive adhesives described in U.S. Pat. No. 6,345,050, fall into the category of elastic barrier adhesives and can provide liquid impermeable properties with some vapor transmission.

The term “vicso-elastic hot melt”, as used herein, is intended to refer to an elastomeric thermoplastic solid that can be melted or extruded at temperatures in excess of 20 to 40° C. The term “pressure sensitive adhesive”, as used herein, is intended to refer to adhesives that bond almost instantaneously when mating surfaces are subjected to pressures forcing them together.

The term “visco-elastic hot melt pressure sensitive adhesive”, “self-adhering composition”, “self-adhering elastic”, and “elastic pressure sensitive adhesive” are used interchangeably herein when referring to elastic materials which adhere to materials suitable for use in disposable absorbent articles and the like, such as paper, cloth, plastic materials, films, filaments, fibers, etc., upon contact or with the use of pressure.

Elastic thermoplastic materials suitable for use in the present invention are desirably soft and flexible. The elastic thermoplastic materials may be supplied to a machine assembly station in roll or bulk form, or they may be extruded through suitable dies. The elastomers may be autogenously bonded to the liner material (32) using only heat and pressure, or they may be fusioned or self-bonded to the liner material (32) immediately subsequent to their extrusion or they may be co-extruded with a suitable adhesive.

In addition to self-bonding, autogenous bonding, and fusion bonding, the non-tensioned elastic (34) may be connected or otherwise associated with the liner material (32) in a variety of configurations via a suitable adhesive. The adhesive may be either of the flexible or rigid type, depending on the manner of application, such as line, intermittent, dot, dash, or any other suitable configuration.

The elastic ribbons may be applied with applicators both hot and cold. They may be extruded and co-extruded whereby they are extruded with one or both of the materials to be bonded to each other. Suitable adhesives include pressure sensitive, cold adhesives, hot melts, releasable adhesives, and pressure sensitive hot melts.

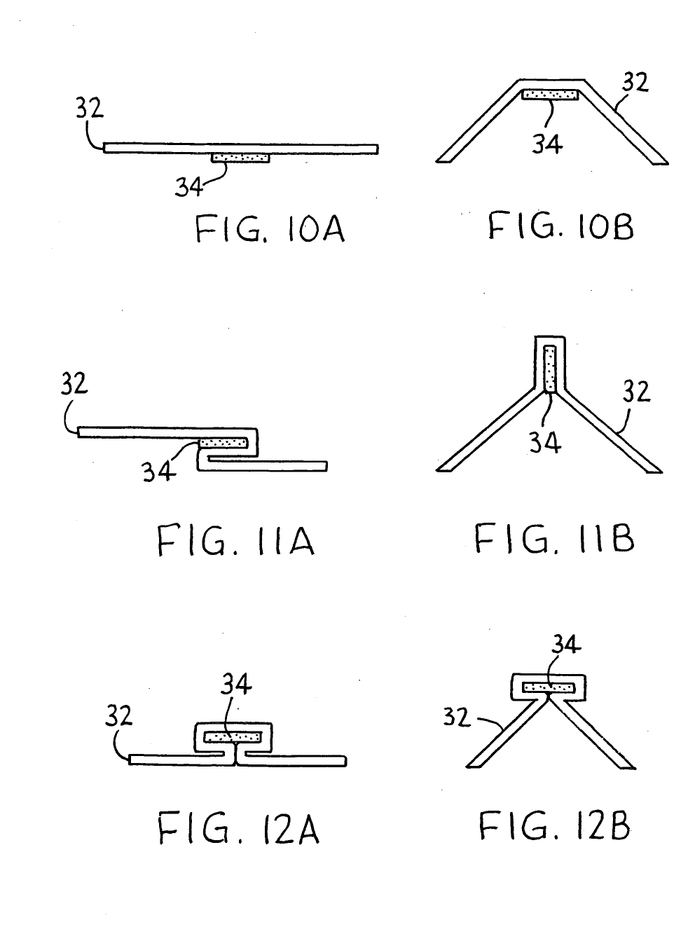

Depending on the general design and intended use of the absorbent article, at least a portion of the non-tensioned elastic (34) may be connected or otherwise associated with at least a portion of the liner material (32) in a variety of configurations, including, for example, a flat application (see FIGS. 10A and 10B), a folded application (see FIGS. 11A and 11B), or a “T” folded application (see FIGS. 12A and 12B), as well as combinations thereof.

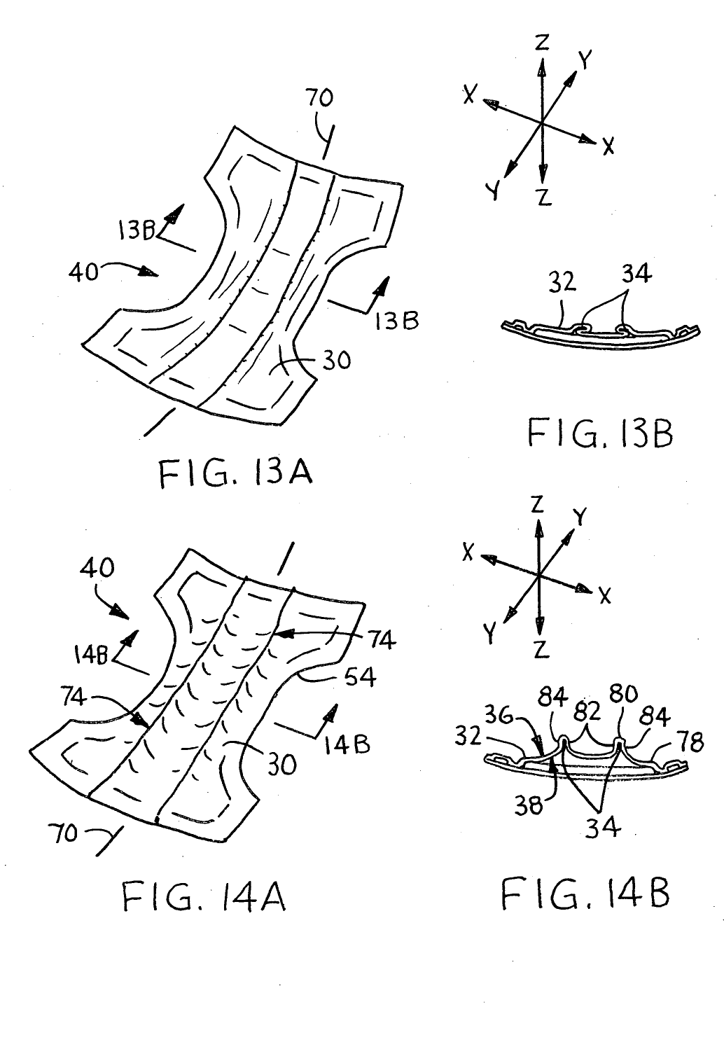

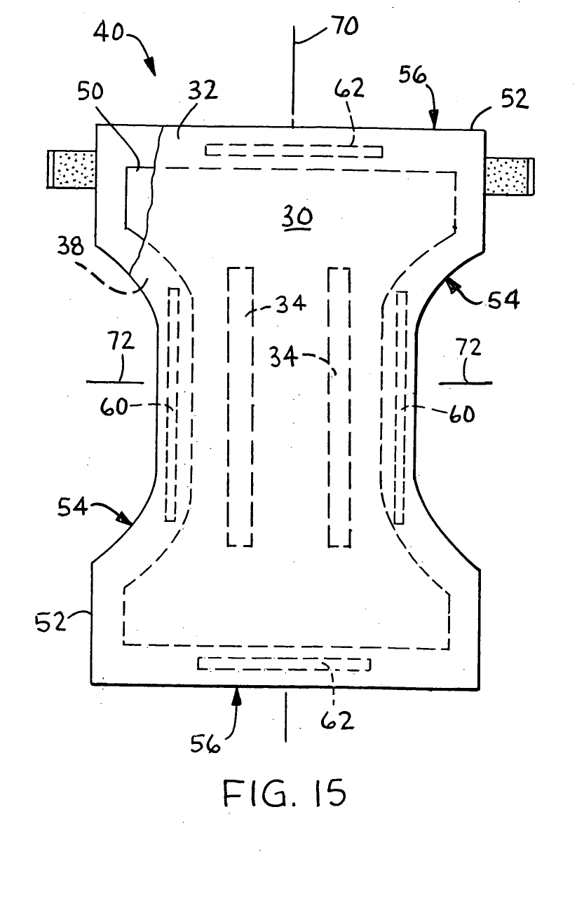

Developers of disposable absorbent articles have long strived to achieve their vision of absorbent articles that are relatively thin, smooth, and flat in their appearance. In the case of absorbent articles such as disposable diapers, training pants, and adult incontinent garments, this vision frequently translates into a desire for absorbent articles that have the look and feel of underwear. Through the discovery of the liner composites (30) disclosed herein, this vision is quickly becoming a reality. By associating the extensible liner material (32) with the discrete placement of a non-tensioned elastic (34) thereon, the resulting two-dimensional liner composite (30) is relatively thin, smooth, and flat as illustrated in FIGS. 13A and 13B. However, when placed into an absorbent article such as a disposable diaper, a portion of the liner composite (30) (at least that portion of the liner composite (30) adjacent where the liner material (32) and the non-tensioned elastic (34) are connected or otherwise associated) may be activated, resulting in at least a portion of the non-tensioned elastic (34) stretching and then retracting back to near its original dimension(s), and at least a corresponding portion of the liner material (32) extending and substantially maintaining its extended dimension(s). This phenomenon upon activation (i.e., when the absorbent article is being donned on the wearer or during use by the wearer) creates a three-dimensional effect on at least one of the surfaces (36, 38) of the liner material (32) of the liner composite (30). The size, shape, amplitude and frequency of the three-dimensional effect is believed to be determined by the placement of the non-tensioned elastic (34) and the retraction capability differential between the non-tensioned elastic (34) and the corresponding portion(s) of the liner material (32).

Use of the term “retraction capability differential” herein is intended to refer to the difference between the amount the non-tensioned elastic (34) retracts from its extended dimension and the amount the extensible liner material (32) retracts from its extended dimension. For example, a retraction capability differential of 10% results when a non-tensioned elastic (34) retracts 10% from its extended dimension and the corresponding extensible liner material (32) maintains its extended dimension and does not retract. Suitable configurations of the liner composite (30)—or portions thereof—typically have a retraction capability differential of no less than 5; alternatively, no less than 10; alternatively, no less than 15; alternatively, no less than 20; alternatively, no less than 25; alternatively, no less than 30; alternatively, no less than 35; alternatively, no less than 40; alternatively, no less than 45; alternatively, no less than 50; alternatively, no less than 55; alternatively, no less than 60; alternatively, no less than 65; alternatively, no less than 70; alternatively, no less than 75; alternatively, no less than 80; alternatively, no less than 85; or finally, alternatively, no less than 90%. In addition, suitable configurations of the liner composite (30)—or portions thereof—typically have a retraction capability differential of no more than 95; alternatively, no more than 90; alternatively, no more than 85; alternatively, no more than 80; alternatively, no more than 75; alternatively, no more than 70; alternatively, no more than 65; alternatively, no more than 60; alternatively, no more than 55; alternatively, no more than 50; alternatively, no more than 45; alternatively, no more than 40; alternatively, no more than 35; alternatively, no more than 30; alternatively, no more than 25; alternatively, no more than 20; alternatively, no more than 15; or finally, alternatively, no more than 10%. Thus, suitable configurations of the liner composite (30)—or portions thereof—may exhibit a retraction capability differential ranging between no less than 5% up to no more than 95%; although the approximate retraction capability differential may vary according to, inter alia, the general design and intended use of the liner composite (30).

The various aspects, benefits, and versions of the liner composite (30) will be described in the context of a disposable absorbent article, such as a disposable diaper. It is, however, readily apparent that one or more versions of the present invention could also be employed with other disposable absorbent articles, such as feminine hygiene articles, children's training pants, adult incontinence garments and the like. Typically, disposable absorbent articles are intended for limited use and are not intended to be laundered or otherwise cleaned for reuse. A disposable diaper, for example, is discarded after it has become soiled by the wearer. Optionally, a disposable diaper may include a single-use, absorbent insert, and a limited-use outer cover which may be reused several times.

FIGS. 15 and 16 illustrate a disposable diaper (40) as having a front portion (42), a rear portion (44), and a crotch portion (46) located between the front and rear portions. The disposable diaper includes an outer cover (48), a bodyside liner composite (30), and an absorbent core (50) situated between the outer cover (48) and the liner composite (30). The outer edges of the diaper (40) define a periphery (52) with laterally opposed, longitudinally extending side edges (54); longitudinally opposed, laterally extending end edges (56); and a system of elastomeric gathering members, such as a system including leg elastics (60) and waist elastics (62). The longitudinal side edges (54) define leg openings (58) for the diaper (40), and optionally, are curvilinear and contoured. The lateral end edges (56) are illustrated as straight, but optionally, may be curvilinear. The diaper (40) may also include additional components to assist in the acquisition, distribution and storage of bodily waste. For example, the diaper (40) may include a transport layer, such as described in U.S. Pat. No. 4,798,603, issued to Meyer et al. (attorney docket number 8,263), or a surge management layer, such as described in European Patent Application Publication No. 0 539 703 (attorney docket number 9,922), published May 5, 1993.

With regard to the designated surfaces of the absorbent article and its components, the various upper or bodyfacing surfaces are configured to face toward the body of the wearer when the absorbent article is worn by the wearer for ordinary use. The various opposing or lower surfaces are configured to face away from the wearer's body when the absorbent article is worn by the wearer.

The diaper (40) generally defines a longitudinally extending length dimension (64), and a laterally extending width dimension (66), as representatively illustrated in FIG. 16. The diaper may have any desired shape, such as rectangular, I-shaped, a generally hourglass shape, or a T-shape.

The outer cover (48) and the liner composite (30) may be generally coextensive (e.g., FIG. 16), or optionally, may be non-coextensive. Either or both of the outer cover (48) and the liner composite (30) may have length and width dimensions which are generally larger than those of the absorbent core (50) and extend beyond the corresponding dimensions of the absorbent core (50) to provide longitudinal side edges (54) and lateral end edges (56) which may be connected or otherwise associated together in an operable manner. As used herein when describing the liner composite (30) in relation to the outer cover (48) and vice versa, the term “associated” encompasses configurations in which the liner composite (30) is directly joined to the outer cover (48), and configurations where the liner composite (30) is indirectly joined to the outer cover (48) by affixing portions of the liner composite (30) to intermediate members which in turn are affixed to at least portions of the outer cover (48). The liner composite (30) and the outer cover (48) can, for example, be joined to each other in at least a portion of the diaper periphery (52) by attachment mechanisms (not shown) such as adhesive bonds, sonic bonds, thermal bonds, pinning, stitching, or a variety of other attachment techniques known in the art, as well as combinations thereof.

The outer cover (48) may suitably be composed of a material which is either liquid permeable or liquid impermeable. It is generally desirable that the outer cover (48) be formed from a material which is substantially liquid impermeable. For example, a typical outer cover (48) can be manufactured from a thin plastic film or other flexible liquid impermeable material. For example, the outer cover (48) may be formed from a polyethylene film having a thickness of from about 0.012 mm (0.5 mil) to about 0.051 mm (2.0 mils). If desirous of presenting the outer cover (48) with a more cloth-like feel, the outer cover (48) may include a polyethylene film having laminated to the lower or opposing surface thereof a nonwoven web, such as a spunbond web of polyolefin fibers. For example, a polyethylene film having a thickness of about 0.015 mm (0.6 mil) may have thermally laminated thereto a spunbond web of polyolefin fibers, which fibers have a thickness of about 1.5 to about 2.5 denier per filament, which nonwoven web has a basis weight of about 24 gsm (0.7 osy). Methods of forming such cloth-like outer covers are known to those skilled in the art.

Further, the outer cover (48) may be formed of a woven or nonwoven fibrous web layer which has been totally or partially constructed or treated to impart a desired level of liquid impermeability to selected regions that are adjacent or proximate the absorbent core (50). Still further, the outer cover (48) may optionally be composed of micro-porous “breathable” material which permits vapors to escape from the absorbent core (50) while still preventing liquid exudates from passing through the outer cover (48).

The absorbent core (50) may include a matrix of hydrophilic fibers, such as a web of cellulosic fluff, mixed with particles of a high-absorbency material commonly known as superabsorbent material. In a particular version, the absorbent core (50) includes a mixture of superabsorbent hydrogel-forming particles and wood pulp fluff. The wood pulp fluff may be exchanged with synthetic polymeric, meltblown fibers or with a combination of meltblown fibers and natural fibers. The superabsorbent particles may be substantially homogeneously mixed with the hydrophilic fibers or may be non-uniformly mixed.

The absorbent core (50) may have any of a number of shapes. For example, the absorbent core (50) may be rectangular, I-shaped or T-shaped. It is generally desired that the absorbent core (50) be narrower in the crotch portion than the rear or front portion(s).

The high-absorbency material can be selected from natural, synthetic and modified natural polymers and materials. The high-absorbency materials can be inorganic materials, such as silica gels, or organic compounds, such as crosslinked polymers. The term “crosslinked” refers to any means for effectively rendering normally water-soluble materials substantially water insoluble, but swellable. Such means can include, for example, physical entanglement, crystalline domains, covalent bonds, ionic complexes and associations, hydrophilic associations, such as hydrogen bonding, and hydrophobic associations or Van der Waals forces.

Examples of synthetic, polymeric, high-absorbency materials include the alkali metal and ammonium salts of poly(acrylic acid) and poly(methacrylic acid), poly(acrylamides), poly(vinyl ethers), maleic anhydride copolymers with vinyl ethers and alpha-olefins, poly(vinyl pyrolidone), poly(vinyl morpholinone), poly(vinyl alcohol), and mixtures and copolymers thereof. Further polymers suitable for use in the absorbent core include natural and modified natural polymers, such as hydrolyzed acrylonitrile-grafted starch, acrylic acid grafted starch, methyl cellulose, carboxymethyl cellulose, hydroxypropyl cellulose, and the natural gums, such as alginates, xanthum gum, locust bean gum, and the like. Mixtures of natural and wholly or partially synthetic absorbent polymers can also be useful. Processes for preparing synthetic, absorbent gelling polymers are disclosed in U.S. Pat. No. 4,076,663, issued to Masuda et al., and U.S. Pat. No. 4,286,082, issued to Tsubakimoto et al.

The high-absorbency material may be in a variety of geometric forms. It is desired that the high-absorbency material be in the form of discrete particles. However, the high-absorbency material may also be in the form of fibers, flakes, rods, spheres, needles, or the like. Often, the high-absorbency material is present in the absorbent core (50) in an amount of from about 5 to about 100 weight percent based on total weight of the absorbent core (50).

The liner composites (30) of the present invention are suitable for incorporation into a variety of other diaper configurations, as well as training pants, incontinence garments, and other disposable absorbent article configurations. For example, the liner composites (30) of the present invention may be incorporated into disposable diapers similar to those described in U.S. Pat. No. 5,509,915, issued to Hanson et al. (attorney docket number 9,922.1), and U.S. Pat. No. 5,192,606, issued to Proxmire et al. (attorney docket number 9,932).

Referring again to FIGS. 15 and 16, illustrated are versions of a diaper (40) in its generally flat-out or pre-activated state. The diaper (40) includes a liner composite (30) and an outer cover (48) which are coextensive and have length and width dimensions generally larger than those of an absorbent core (50). The liner composite (30) is associated with and superposed on the outer cover (48) to thereby form the periphery (52) of the diaper (40). The periphery (52) defines an outer perimeter or edge(s) of the diaper (40). The periphery (52) generally includes longitudinal side edges (54) and lateral end edges (56). The diaper (40) additionally has a longitudinal centerline (70) and a lateral centerline (72). In each of the illustrated versions, the liner composite (30) includes an extensible, fluid permeable liner material (32) having a bodyfacing or upper surface (36) and an opposing or lower surface (38). The liner composite (30) also includes portions of a non-tensioned elastic (34) connected or otherwise associated with portions of the lower surface (38) of the liner material (32). The non-tensioned elastic (34) is positioned inboard from the longitudinal side edges (54) of the diaper (40) and runs in a direction generally parallel to the longitudinally extending length dimension (64) of the diaper (40). The term “inboard” is intended to refer to the direction from an edge (54, 56) toward a respective centerline (70, 72). The term “outboard” is intended to refer to a direction away from a respective centerline (70, 72). As a result of the illustrated diaper (40) being in its pre-activated state, the diaper (40) thus retains its somewhat two-dimensional configuration with the upper surface (36) of the liner composite (30) being substantially smooth in appearance.

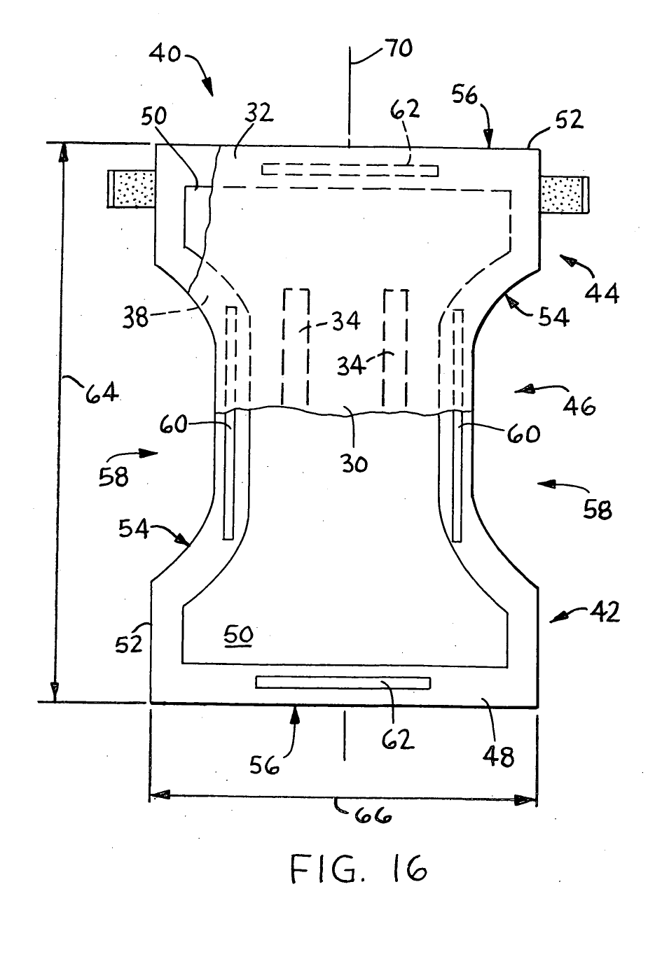

Turning now to FIGS. 14A and 14B, upon donning on the wearer or while in use by the wearer, at least a portion of the liner composite (30) of the diaper (40) is activated. That portion of the liner composite (30) that is activated typically has a retraction capability differential of at least 10% and is adapted to attain a three-dimensional configuration. In the illustrated version, at least that portion of the liner composite (30) adjacent where the liner material (32) and the non-tensioned elastic (34) are connected or otherwise associated attains the three-dimensional configuration by forming a barrier element (74). As illustrated, the barrier element (74) runs in a longitudinally-oriented direction and is disposed inboard from the longitudinal side edge (54) toward the longitudinal centerline (70). The barrier element (74) is disposed inboard of the longitudinal side edge (54) so that exudates, especially loose fecal material which is not easily absorbed and tends to float along the upper surface (36) of the liner material (32), will contact the barrier element (74) before it can contact the longitudinal side edge (54). The barrier element (74) is desirably disposed between the longitudinal side edge (54) and the longitudinal centerline (70) of the diaper (40). Alternatively, the barrier element (74) is disposed between the leg elastics (60) and the longitudinal centerline (70) in at least the crotch portion (46) of the diaper (40).

In another version (not specifically illustrated), at least a portion of the liner composite (30) of the diaper (40) is activated upon donning on the wearer or while in use by the wearer. That portion of the liner composite (30) that is activated typically has a retraction capability differential of at least 10% and is adapted to attain a three-dimensional configuration. In this version, at least that portion of the liner composite (30) adjacent where the liner material (32) and the non-tensioned elastic (34) are connected or otherwise associated attains the three-dimensional configuration by forming a barrier element (74). In such a version, the barrier element (74) runs in a laterally-oriented direction and is disposed inboard from a lateral end edge (56) toward the lateral centerline (72) (see, for example, FIG. 7). The barrier element (74) is disposed inboard of the lateral end edge (56) so that exudates, especially loose fecal material which is not easily absorbed and tends to float along the upper surface (36) of the liner material (32), will contact the barrier element (74) before it can contact the lateral end edge (56). The barrier element (74) is desirably disposed between a lateral end edge (56) and the lateral centerline (72) of the diaper (40). Alternatively, the barrier element (74) is disposed between the waist elastics (62) and the lateral centerline (72) in at least the front portion (42) or the rear portion (44) of the diaper (40). In other versions, the barrier element (74) is desirably disposed between the waist elastics (62) and the lateral centerline (72) in both the front portion (42) and the rear portion (44) of the diaper (40).

Referring again to FIGS. 14A and 14B, a barrier element (74) typically has a base region (78), a distal edge (80), an inboard surface (82), and an outboard surface (84). The base region (78) and the distal edge (80) are in spaced relation to each other and define the height (typically in the z-direction) of the barrier element (74). The base region (78) and the distal edge (80) may be in a substantially parallel, non-parallel, rectilinear or curvilinear relationship. In addition, the barrier element (74) may have a variety of different cross-sectional areas including circular, square, rectangular or any other suitable shape. Desirably, the base region (78) is spaced from the distal edge (80) in a parallel and rectilinear relationship to provide a barrier element (74) having a substantially uniform height. Suitably, a barrier element (74) attains a height in accordance with its general design and intended use. In certain versions of the present invention, suitable barrier elements (74) have a height of at least 5 mm, or, alternatively, at least 10 mm to no more than 25 mm. It also may be desirable to impart at least a portion of a barrier element (74) with the properties of being liquid impermeable. One such method would be to render at least a portion of the barrier element (74) liquid impermeable through a variety of known surface treatments. An alternative method of introducing liquid impermeable properties to at least a portion of a barrier element (74) would be through the incorporation of an elastic barrier adhesive as at least a portion of the non-tensioned elastic (34).

Although previously described as being adapted to attain a three-dimensional configuration such as a barrier element (74) upon activation, the liner composites (30) disclosed herein are also capable of obtaining a variety of other three-dimensional configurations upon activation. For example, a liner composite (30) incorporated into an absorbent article may be adapted to attain a three-dimensional configuration resulting in at least a portion of the liner composite (30) residing close to the body of the wearer. In a specific version, the liner composite may attain a three-dimensional configuration that brings that portion of the liner composite (30) residing in the rear portion (44) of a diaper (40) into contact with a portion of the gluteal fold region between the buttocks of the wearer's body. One such configuration is illustrated in FIG. 8, with the fit element (90) being that portion of the liner composite (30) adapted to attain a close-to-the-body three-dimensional configuration upon activation.

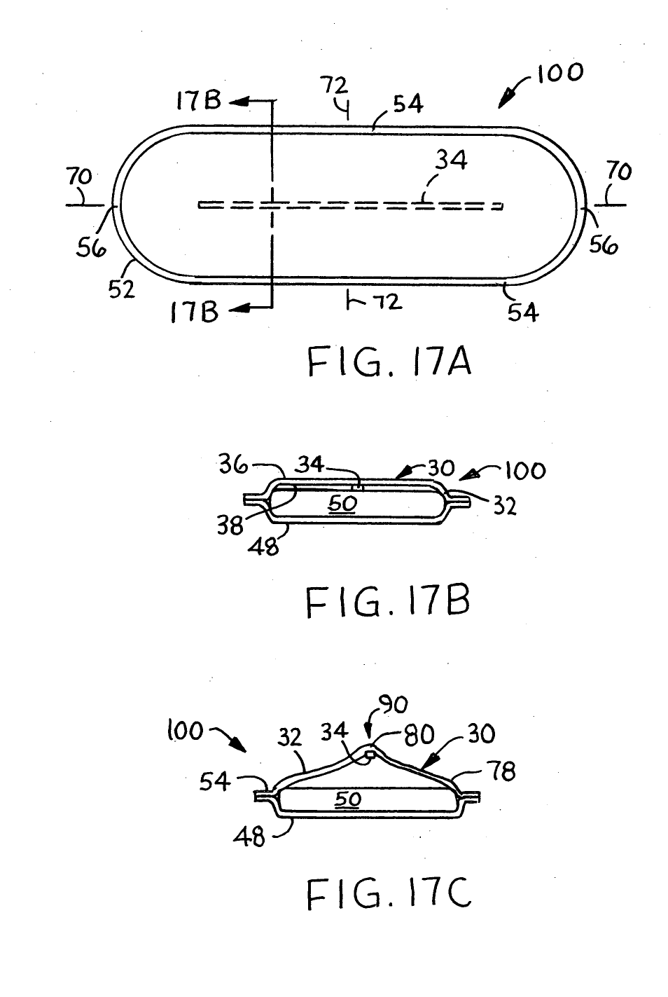

Referring now to FIGS. 17A and 17B, an alternative configuration is illustrated that would be suitable for bringing at least a portion of the upper surface (36) of a liner composite (30) of another disposable absorbent article, in this instance a feminine hygiene article (such as a sanitary napkin or pad), into close proximity with the vestibular region or, more specifically, the vaginal orifice of a female wearer. The vestibular region is considered to be the point of discharge for menses. The sanitary napkin (100) of FIGS. 17A and 17B is illustrated as being in its generally flat-out or pre-activated state. The sanitary napkin (100) includes a liner composite (30) and an outer cover (48) which are coextensive and have length and width dimensions generally larger than those of an absorbent core (50). The liner composite (30) is associated with and superposed on the outer cover (48) to thereby form the periphery (52) of the sanitary napkin (100). The periphery (52) defines the outer perimeter or edge(s) of the sanitary napkin (100). The periphery (52) generally includes longitudinal side edges (54) and lateral end edges (56). The sanitary napkin (100) additionally has a longitudinal centerline (70) and a lateral centerline (72). In the illustrated version, the liner composite (30) includes an extensible, fluid permeable liner material (32) having a bodyfacing or upper surface (36) and an opposing or lower surface (38). The liner composite (30) also includes portions of a non-tensioned elastic (34) connected or otherwise associated with portions of the lower surface (38) of the liner material (32). The non-tensioned elastic (34) is positioned inboard from the longitudinal side edges (54) of the sanitary napkin (100) and runs in a direction generally parallel to the longitudinal centerline (70) of the sanitary napkin (100). As a result of the illustrated sanitary napkin being in its pre-activated state, the sanitary napkin (100) thus retains its somewhat two-dimensional configuration with the upper surface (36) of the liner composite (30) being substantially smooth in appearance.

Turning now to FIG. 17C, upon placement in the crotch region of a female's anatomy or while in use by the wearer, at least a portion of the liner composite (30) of the sanitary napkin (100) is activated. That portion of the liner composite (30) that is activated typically has a retraction capability differential of at least 10% and is adapted to attain a three-dimensional configuration. In the illustrated version, at least that portion of the liner composite (30) adjacent where the liner material (32) and the non-tensioned elastic (34) are connected or otherwise associated attains the three-dimensional configuration by forming a fit element (90). As illustrated in FIG. 17C, the fit element (90) runs in a substantially longitudinally-oriented direction and is disposed inboard from the longitudinal side edge (54) toward the longitudinal centerline (70). Desirably, the fit element (90) resides on or adjacent the longitudinal centerline (70) of the sanitary napkin (100).

Similar to a barrier element (74), a fit element (90) typically has at least a base region (78) and a distal edge (80). The base region (78) and the distal edge (80) are in spaced relation to each other and define the height (typically in the z-direction) of the fit element (90). The base region (78) and the distal edge (80) may be in a substantially parallel, non-parallel, rectilinear or curvilinear relationship. In addition, the fit element (90) may have a variety of different cross-sectional areas including circular, square, rectangular or any other suitable shape. Suitably, a fit element (90) has a height in accordance with its general design and intended use. In certain versions of the present invention, suitable fit elements (90) have a height of at least 5 mm, or, alternatively, at least 10 mm to no more than 25 mm.

Although described herein as being substantially entirely extensible, one of skill in the art will readily appreciate that certain portions of the liner composite (30) can be made substantially non-extensible by affixing one or more portions of the extensible liner material (32) to one or more portions of a substantially non-extensible component, such as, for example, a substantially non-extensible outer cover (48) or a substantially non-extensible absorbent core (50).

As previously mentioned, conventional disposable absorbent articles often include mechanical systems for controlling the movement of body wastes. Typically, such mechanical systems are created by adding a second substrate with tensioned elastic. These mechanical systems are generally then applied to the upper or bodyfacing surface of an absorbent article, allowing the tensioned elastic to retract. By allowing the elastic to retract, at least a portion of the absorbent article has a tendency to curl or deform thus making the absorbent article more difficult to manufacture and subsequently package. In addition, such conventional absorbent articles demonstrate a desire to curl even when donning on the wearer. The liner composites (30) of the present invention contribute to a reduction in these problems and will allow developers of disposable absorbent articles to take a step toward their vision of disposable absorbent articles that are relatively thin, smooth, and flat in their appearance. The liner composites (30) discussed herein also represent a contribution toward the development of disposable absorbent articles that are relatively easier to manufacture and have less complex-appearing bodyfacing surfaces prior to being donned on a wearer. It is believed that certain disposable absorbent articles incorporating the liner composites (30) of the present invention will be thinner in appearance. By reducing the thickness of a disposable absorbent article, manufacturers will be able to package more absorbent articles in a given package size, or alternatively, manufacturers will be able to package a similar number of absorbent articles in a smaller package size.

### Test Method(s)

A suitable technique for determining the amount of elongation and/or retractive force parameters of a selected component or material can employ ASTM Standard Test Method D882 (Tensile Method for Tensile Properties of Thin Plastic Sheeting) dated December 1995, with the following particulars. The “width” of the test sample will be a cross-wise width which can be conveniently obtained from the product being tested, and is desirably about 2 inches (about 5 cm). The test sample width is perpendicular to the direction of the tensile force applied during the testing. With regard to the illustrated configurations, for example, the test sample “width” generally corresponds to the length-wise dimension of the extensible liner material (32), for example, along the longitudinally-extending length dimension of the article. The initial separation of the jaws of the tensile tester is 3 inches (7.62 cm), and the moving jaw is moved at a constant rate of 50 mm/min. The moving jaw is stopped at an extension of 50 mm for a period of 10 seconds, and then returned back to its initial starting position at a rate of 50 mm/min. The force-extension curve to the complete tension and retraction cycle can be recorded on a conventional computer equipped with commercially available software, such as TestWorks for Windows, version 3.09, which is available from MTS System Corporation, a business having a location at 14000 Technology Drive, Eden Prairie, Minn. The obtained data is normalized and reported in appropriate units of force per unit length of sample “width” (e.g., grams-force per inch or Newtons per inch; or grams-force per centimeter or Newtons per centimeter).

Having described the invention in rather full detail, it will be readily apparent that various changes and modifications can be made without departing from the spirit of the invention. All of such changes and modifications are contemplated as being within the scope of the invention as defined by the appended claims and any equivalents thereto.

1. A disposable absorbent article having a longitudinal centerline (70) and a lateral centerline (72), the article comprising:
a liquid impermeable outer cover (48);
a liner composite (30), the liner composite (30) including: (a) an extensible, fluid permeable liner material (32) having an upper surface (36) and an opposing lower surface (38); and (b) a non-tensioned elastic (34), the non-tensioned elastic (34) being associated with at least a portion of a surface (36, 38) of the liner material (32), wherein upon activation at least a portion of the liner composite (30) adjacent where the liner material (32) and the non-tensioned elastic (34) are associated is adapted to (i) have a retraction capability differential of at least 10% and (ii) attain a three-dimensional configuration, and wherein at least that portion of the liner material (32) adjacent where the liner material (32) and the non-tensioned elastic (34) are associated is adapted to extend no less than 25%; and
an absorbent core (50) disposed intermediate the outer cover (48) and the liner composite (30).

2. The disposable absorbent article of claim 1, wherein the three-dimensional configuration is a barrier element (74).

3. The disposable absorbent article of claim 2, wherein the non-tensioned elastic (34) is associated with the lower surface (38) of the liner material (32).

4. The disposable absorbent article of claim 2, wherein the liner composite (30) is associated with and superposed on the outer cover (48) to thereby form a periphery (52), the periphery (52) generally including longitudinal side edges (54) and lateral end edges (56).

5. The disposable absorbent article of claim 4, wherein the barrier element (74) runs in a longitudinally-oriented direction and is disposed inboard from a longitudinal side edge (54) toward the longitudinal centerline (70).

6. The disposable absorbent article of claim 5, further comprising a leg elastic (60) wherein the barrier element (74) is disposed between the leg elastic (60) and the longitudinal centerline (70).

7. The disposable absorbent article of claim 5, wherein at least a portion of the barrier element (74) is liquid impermeable.

8. The disposable absorbent article of claim 4, wherein the barrier element (74) runs in a laterally-oriented direction and is disposed inboard from a lateral end edge (56) toward the lateral centerline (72).

9. The disposable absorbent article of claim 8, further comprising a waist elastic (62) wherein the barrier element (74) is disposed between the waist elastic (62) and the lateral centerline (72).

10. The disposable absorbent article of claim 8, wherein at least a portion of the barrier element (74) is liquid impermeable.

11. The disposable absorbent article of claim 1, wherein the three-dimensional configuration is a fit element (90).

12. The disposable absorbent article of claim 11, wherein the non-tensioned elastic (34) is associated with the lower surface (38) of the liner material (32).

13. The disposable absorbent article of claim 11, wherein the liner composite (30) is associated with and superposed on the outer cover (48) to thereby form a periphery (52), the periphery (52) generally including longitudinal side edges (54) and lateral end edges (56).

14. The disposable absorbent article of claim 13, wherein the fit element (90) is disposed inboard from a longitudinal side edge (54) toward the longitudinal centerline (70).

15. The disposable absorbent article of claim 14, wherein the fit element (90) runs in a substantially longitudinally-oriented direction.

16. The disposable absorbent article of claim 11, wherein a portion of the fit element (90) resides on the longitudinal centerline (70).

17. The disposable absorbent article of claim 16, wherein the fit element (90) runs in a substantially longitudinally-oriented direction.

18. A liner composite (30) suitable for incorporation into a disposable absorbent article, the liner composite (30) comprising: (a) an extensible, fluid permeable liner material (32) having an upper surface (36) and an opposing lower surface (38); and (b) a non-tensioned elastic (34), the non-tensioned elastic (34) being joined to a portion of a surface (36, 38) of the liner material (32), and wherein upon activation at least that portion of the liner composite (30) adjacent where the liner material (32) and the non-tensioned elastic (34) are associated is adapted to: (i) have a retraction capability differential of at least 10% and (ii) attain a three-dimensional configuration.

19. The liner composite (30) of claim 18, wherein the three-dimensional configuration has a distal edge (80) and a base region (78), the distal edge (80) and the base region (78) being in spaced relation to each other.

20. The liner composite (30) of the claim 19, further comprising a longitudinal centerline (70) and a lateral centerline (72).

21. The liner composite (30) of claim 20, wherein the three dimensional configuration is a barrier element (74).

22. The liner composite (30) of claim 21, wherein the non-tensioned elastic (34) is associated with the lower surface (38) of the liner material (32).

23. The liner composite (30) of claim 21, wherein the barrier element (74) runs in a longitudinally-oriented direction and is disposed outboard from the longitudinal centerline (70).

24. The liner composite (30) of claim 23, wherein at least a portion of the barrier element (74) is liquid impermeable.

25. The liner composite (30) of claim 21, wherein the barrier element (74) runs in a laterally-oriented direction and is disposed outboard from the lateral centerline (72).

26. The liner composite (30) of claim 25, wherein at least a portion of the barrier element (74) is liquid impermeable.

27. The liner composite (30) of claim 20, wherein the three dimensional configuration is a fit element (90).

28. The liner composite (30) of claim 27, wherein the non-tensioned elastic (34) is associated with the lower surface (38) of the liner material (32).

29. The liner composite (30) of claim 27, wherein the fit element (90) is disposed outboard from the longitudinal centerline (70).

30. The liner composite (30) of claim 27, wherein a portion of the fit element (90) resides on the longitudinal centerline (70).

31. The liner composite (30) of claim 28, wherein the fit element (90) runs in a substantially longitudinally-oriented direction.
